(19) United States
(12) Patent Application Publication
(10) Pub. No.: US 2011/0264575 A1
(43) Pub. Date: Oct. 27, 2011

(54) FARMLAND INDEX SYSTEM

(76) Inventor: Paul Kanitra, Greensboro, GA (US)

(21) Appl. No.: 13/177,729

(22) Filed: Jul. 7, 2011

Related U.S. Application Data
(63) Continuation-in-part of application No. 12/322,666, filed on Feb. 5, 2009, now abandoned.

(51) Int. Cl. G06Q 40/00

(52) U.S. Cl. 705/35

(57) ABSTRACT

A system for developing farmland indexes. The system is a computerized system that includes software code for receiving information on farmland properties from deeds, receiving capability class ratings and farmland classifications for the properties, discarding ineligible properties from analysis, and assigning a price on farmland properties.

### CLAIM OF PRIORITY

This application is a continuation in part of co-pending U.S. Non-Provisional patent application Ser. No. 12/322,666, filed on Feb. 5, 2009.

### FIELD OF THE INVENTION

The present invention relates to the farmland indexes and, in particular, to systems for developing farmland indexes and classes thereof.

### BACKGROUND OF THE INVENTION

Real estate indexes are a commonly used tool for approximating real estate values at any given time. Such indexes pull information from various sources using various methodologies in order to provide statistics that represent real estate market performance. These indexes are used by mortgage lenders, securities issuers, insurers, and ratings agencies, as well as real estate purchasers and investors. Examples of such indexes include the S&P/Case-Shiller Home Price Indexes and the Radar Logic Index, each of which are specific to real estate markets. Although these existing indexes are helpful tools in the residential real estate market, they are not specific to farmland real estate, in that the data collected to form the indexes does not include data specific and important to determining the value of farmland.

Some farmland specific indexes currently exist, but each has significant drawbacks and none has gained market trust as a legitimate proxy investment to farmland. For example, the NCREIF Farmland Index is a quarterly time series composite return measure of investment performance of a large pool of individual agricultural properties. However, the makeup of this pool and the methodology used in determining investment performance, seriously limits the effectiveness of this index. First, land must be acquired in the private market for investment purposes only and all properties in the Farmland Index have been acquired, at least in part, on behalf of tax-exempt institutional investors and are held in a fiduciary environment. Therefore, privately held farmland is specifically excluded from this index. Second, this index only considers income producing properties, meaning that the land must currently be cultivated or rented for such purposes. This further excludes the applicability of the index, as land that could be used as farmland but is not now used for this purpose is specifically excluded. Third, the appreciated value of each member property in each quarter is set by a submission of a market value for the property by the property's owner and not by any independent valuation methodology, such as defined actual farmland sales. Fourth, even with an independent third party submission of market value, such valuation would represent a survey or estimate of market value. The pricing would still not consist of actual recorded farmland sales. Finally, as the properties that make up this index are held for long periods of time by its owners, there exists no ability to replicate the index in the physical or exchange traded markets.

Another farmland price index has been developed by Creighton University. This Rural Mainstreet Index is a monthly index set as a number from 0 to 100 and is based upon agricultural surveys of rural banks conducted in Colorado, Illinois, Iowa, Kansas, Minnesota, Nebraska, North Dakota, South Dakota and Wyoming. This index also has significant drawbacks. Firstly, the index only attempts to measure forward confidence. The overall index ranges between 0 and 100 percent. An index number greater than 50 percent indicates an expansionary economy, and an index under 50 percent forecasts a sluggish economy, for the next three to six months. Second, it fails to take into account the quality of the land in question and its individual features. Finally, because it is based upon surveys, it does not use objective data to set values. Thus, this index is adapted for use solely as an economic confidence indicator attempting to reflect future expectations. The index uses surveys considering incidentals such as farmland prices, farm equipment, loan volume, economic index, hiring, etc. and is not a legitimate proxy investment to farmland.

Therefore there is a need for a reliable real estate index specific to farmland property that approximates farmland value based on attributes of the farmland, that uses objective valuation methodologies, that is not limited to land that is currently under cultivation, is not limited to investment land or land that is in foreclosure, and is adapted for replication in physical or exchange traded markets.

### SUMMARY OF THE INVENTION

The present invention is a hybrid delivery system for farmland contracts; an index system for developing multiple farmland indexes that provides a legitimate average price per acre based on the quality of the land, index requirements and geographic preferences; and the index or indexes formed by the index system.

The present delivery system is based on the inventor's prior invention, which is disclosed in patent application Ser. No. 12/322,666, filed on Feb. 5, 2009, and is a system for commoditizing farmland, a system for fulfilling futures contracts for the purchase and sale of farmland, and a system for settlement of farmland futures contracts. This prior invention is described below to provide the necessary background for understanding the present invention.

The prior system for commoditizing farmland is a computerized system that includes a processor and a memory onto which at least one computer program product is stored. The computer program product includes software code that inputs selected soil data for a tract of land, inputs property boundary line data defining a parcel or series of commonly owned parcels within the tract of land, overlays the soil data over a selected parcel or parcels, analyzes certain land quality measures based upon the overlay of the soil data with the boundary line data, classifies the parcel as “Prime Farmland,” “Tier 1 Farmland,” or “Tier 2 Farmland” based upon the result of the analysis of land quality measures, and assigns a size designation to the parcel or group of commonly owned parcels.

One of the key aspects of the prior commoditization system is the overlay of the soil data with data identifying commonly owned parcels of land in order to classify these parcels. The system's analysis of land quality measures based upon the overlay of the soil data with the boundary line data involves a number of separate determinations. The system determines the percentage of the parcel or parcels of land that is “Prime Farmland,” “Farmland of Statewide Importance,” or “Farmland of Unique Importance.” The system determines the percentage of the parcel or parcels of land that is “Prime Farmland if drained,” “Prime Farmland if irrigated,” or “Prime Farmland if irrigated and drained.” The system determines the percentage of the parcel or parcels of land that is water. The system determines the percentage of the parcel or parcels of land that falls under other farmland classifications. These farmland classifications are preferably the standard farmland classifications listed by the Natural Resources Conservation Service (NRCS) in Section 622.03 of its National Soil Survey Handbook (NSSH).

The prior system also determines the percentage of the parcel or parcels having non-irrigated capability class ratings I, II, III, IV, V, VI and VII respectively. These capability class ratings are preferably the standard Land Capability Classifications listed by the NRCS in Section 622.02 of its NSSH.

Once all of the analyses of land quality measures are made, the prior system then assigns a land quality classification by classifying the parcel as “Prime Farmland,” “Tier 1 Farmland,” or “Tier 2 Farmland.” It is noted that parcels classified as “Prime Farmland” do not need to consist solely of land that would be classified as “Prime Farmland” by the National Soil Survey Handbook. Rather, as discussed below, the “Prime Farmland” classification means that a certain percentage of the parcel is “Prime Farmland” and that the parcel meets other predetermined land quality measures.

Another key aspect to the prior system for commoditizing farmland is the assignment of a size designation and acceptable parcel shape that conforms closely to the normal standards of the Public Land Survey System (PLSS). Such size should be a rectangular increment of equal to or less than, but being one half or one quarter of what is commonly known as a “quarter of a quarter,” which is one quarter of a one quarter section of a PLSS survey to the commonly traded futures contract. In the preferred prior system, the size designations assigned by the system are directly correlated to “Contract Grouping Designations” or “Designations” under futures contracts. These Designations are groupings of a particular range of parcels of land, referred to as contracts, for delivery. Each number of contracts within each Designation has a defined set of delivery variables unique to such Designation including, but not limited to, frontage requirements, boundary specifics, shape restrictions and size being determined by the actual number of contracts plus or minus delivery variances. Designation I has the smallest number of contracts that can be grouped together with shared requirements for delivery purposes, while Designation V has the largest number of contracts that can be grouped together with shared requirements for delivery purposes.

In some embodiments of the prior system, the prior system will section a parcel or parcels of land into a series of parcels based upon desired land quality classifications and/or size designations. For example, a certain parcel of land may qualify as Tier I farmland having a size designation IV if the entire parcel is considered. However, based on market pricing, it may be more advantageous to section the parcel so that it qualifies as one parcel of Prime Farmland having a size designation III and one parcel of Tier I farmland having a size designation I. Therefore, some embodiments of the system will automatically make these calculations and present land quality and size designation options for the parcel as a whole and as two or more sections.

The prior system for fulfilling futures contracts for the purchase and sale of farmland is a computerized system that includes a processor and a memory onto which at least one computer program product is stored. The computer program product includes the software code for commoditizing farmland, as described in detail above, to verify that farmland tendered for delivery complies with the terms of each futures contract and to approve the farmland tendered for delivery. The computer program product also includes software code for pairing buyers and sellers for delivery under the futures contracts.

In the preferred prior system, all people who have agreed to sell farmland under futures contracts (hereafter referred to as “shorts”) and intend to make physical delivery must provide the system with property information to identify the property to be delivered, or a “due bill” promising to deliver the required property at a later date, before the system pairs buyers (hereafter referred to as “longs”) with shorts. The “due bill” for any specific Prime Farmland Contract will be specifically known as a “Prime Farmland Due Bill” (PFDB). The “due bill” for any specific Tier 1 Farmland Contract will be specifically known as a “Tier 1 Farmland Due Bill” (T1-FDB). The “due bill” for any Tier 2 Farmland Contract will be specifically known as a “Tier 2 Farmland Due Bill” (T2-FDB). Delivery map zone particulars will further mandate each due bill being more explicitly defined as per a specific delivery region.

Regardless of whether a property description is provided prior to the system pairing off longs with shorts or in connection with the delivery under a due bill, the prior invention software code for commoditizing farmland will use the property description to assign land quality and size designations to the farmland tendered for delivery and compare this with the short's contract requirements to ensure that the tendered farmland complies with the terms of contract. In the preferred embodiment, the prior system inputs delivery configuration requirements for the size designations of the futures contracts and inputs delivery zone requirements and verifies that the parcel tendered for delivery meets both the delivery configuration requirements and delivery zone requirements.

In the preferred prior system, the pairing off of shorts and longs is a two-tiered process. The system first pairs off the largest contractually permissible short positions that have land approved for delivery. In this process, the system first attempts to pair shorts having property of the largest size, i.e. contract parcels of “Designation V,” with a complete match to longs holding contracts for an equal or greater number of contract parcels. The process then works down incrementally through each respective designation ultimately getting to a single contract parcel delivery from “Designation I.” After the system pairs off all short positions that have land approved for delivery, the system pairs off the largest contractually permissible short positions that provided due bills for delivery. The system follows the same process with due bills as it did with land approved for delivery. The system first attempts to pair shorts having due bills requiring property of the largest size with a complete match to longs holding contracts for an equal or greater number of contract parcels. The process then works down through all the designations to a single contract delivery from “Designation I.”

In each pairing process of the prior system, the match selection within any specific number of contracts is preferably made using a random selection process with all eligible increments. In the preferred embodiment, the contracts designated by the short, preferably in one to sixty four, one to thirty two, or one to sixteen contract parcel increments, can only be matched with a long position of an equal or greater number of contracts and shorts having multiple deliveries of the exact same number of blocks may prioritize their preference for any delivery matches. However, it is preferred that a long position may be satisfied by multiple short deliveries of varying size designations.

The prior system for commoditizing farmland and the system for fulfilling futures contracts for the purchase and sale of farmland provide the basis for a series of unique farmland futures. Farmland characteristics will allow structuring of different quality farmland contracts and farmland contracts of specific regions. Contracts may be traded through existing exchanges, or through a newly created exchange. Regardless of how the contracts are traded, the contract settlement system of the prior invention is preferably used to settle contracts. The prior contract settlement system includes all of the features of the prior contract fulfillment system, but also includes the ability to settle contracts without an actual physical delivery of land under the contract.

The prior contract settlement system is a computerized system that includes a processor and a memory onto which at least one computer program product is stored. The computer program product includes the software code for commoditizing farmland, as described in detail above, to verify that farmland tendered for delivery complies with the terms of each futures contract and to approve the farmland tendered for delivery, and the software code for pairing buyers and sellers for delivery under the futures contracts. The computer program product also includes a settlement program that includes software code for creating and managing trading accounts and for closing contracts.

The preferred prior settlement program works with the software for pairing buyers and sellers such that a contract is automatically closed through a cash settlement when a pair-off match does not occur for either a physical delivery or a due bill delivery. The preferred prior settlement program also includes software for closing contracts where a default has occurred, due to the failure of a short to tender either approved land or a due bill, which preferably results in performance margin forfeiture within the contract parameters satisfying contract fulfillment requirements. The preferred prior settlement program also includes the ability to close contracts through the buy-out of a short's due bill obligation and/or through the long's termination of the due bill after a predetermined period of time. Finally, the preferred prior settlement program includes the ability to extend due bill obligations by transferring extension fees from a short's account to a long's account.

The present invention now proposes a farmland commoditization hybrid delivery system. The prior application describes a hybrid delivery system in which delivery means are through a two-tiered process including a series of “Designations,” as discussed above. In some embodiments of the present delivery system, these delivery means disclosed in the prior application are also included. A key difference in the present hybrid delivery system over the hybrid delivery system disclosed in the prior application is the use of conversion factors, as described in detail below. Contract size and delivery parcel specifications have also been changed, as described below.

In its most basic form, the hybrid delivery system of the present invention includes a processor and memory on which a software product for executing the delivery system is stored. The software product includes software means for using conversion factors for equalizing deliverability; software means for updating the conversion factors; software means for adjusting the conversion factors; and software means for using a due bill process.

As would be suspected, there is a significant price disparity between similarly rated lands from state to state. An acre of specifically rated Capability Class farmland in North Dakota is significantly less in price than a similarly rated acre in Illinois. Similar pricing disparities exist with like-kind residential properties from two different locations. With such wide price differences a common cheapest to deliver contract will simply price off the state or location where qualifying land is lowest priced.

A cheapest to deliver contract could prove to be a suitable method for handling deliveries and does offer certain attractions as per the prior patent pending farmland commoditization system, as discussed above. However, there are clear advantages in expanding the delivery possibilities. A conversion factor methodology equalizes deliverability even with the presence of large price discrepancies between states and is now the preferred method.

There is precedence for adopting this type of system. The Government National Mortgage Association (GNMA) futures contract used convergence factors to equalize coupons for delivery on an equivalent yield basis. As with GNMA futures, the conversion factors will prove helpful determining hedge ratios. An owner of 640 acres of Arkansas farmland would not require a short hedge with the same number of contracts as someone owning 640 acres in Illinois.

Treasury futures provide further insight to the use of conversion factors. Treasury long bond futures are defined as nominal 6% coupon instruments of 30 year maturities. However, securities with coupons other than 6% are deliverable and securities other than thirty years in maturity can be delivered. There are many securities that fall within the delivery basket specification range differing in maturity, coupon and price. Treasury futures accord an invoice price adjustment to reflect the actual security being tendered. The use of a conversion factor accommodates the necessary pricing adjustment.

The CME Group states “The conversion factor invoice system is intended to render equally economic delivery of any eligible for delivery, security. But in practice a single security tends to stand out as the cheapest or most economic to deliver in light of the relationship between the cash value of the Treasury and the pro-forma invoice amount.”

The use of conversion factors for farmland futures will equalize the delivery basket with the important difference being, farmland conversion factors are structured to work in reverse and provide less likelihood of a single state standing out as the cheapest or most economically favored land to deliver from.

The software product of the delivery system of the present invention also includes software means for updating conversion factors yearly as base price data for states are made available by the USDA National Agricultural Statistics Services.

The software product of the delivery system of the present invention also includes software means for adjusting conversion factors. “Conversion factor adjustments” are used for selected states maintaining anti-corporate farming laws. The conversion factor methodology allows for discounted factoring for states with ownership restrictions. The system determines adjusted percentage conversion factors designed to lessen the probability of delivery from an anti-corporate farming law states.

The software product of the delivery system of the present invention also includes software means for using a due bill process. The futures contracts delivery mechanism incorporates a due bill process with such instrument having embedded options to both the issuer and holder. The life of such an instrument is preferably up to 12 months in duration. The due bill provides further liquidity to the contracts.

In the preferred present system, similar as with the prior system, all having agreed to sell farmland under futures contracts and intending to make physical delivery must provide the system information identifying the property to be delivered, or a “due bill” promising to deliver the acceptable property at a later date as per delivery rules. The “due bill” for any specific Prime Farmland Contract will be specifically known as a “Prime Farmland Due Bill” (PFDB). The “due bill” for any specific Tier 1 Farmland Contract will be specifically known as a “Tier 1 Farmland Due Bill” (T1-FDB). The “due bill” for any Tier 2 Farmland Contract will be specifically known as a “Tier 2 Farmland Due Bill” (T2-FDB). The “due bill” for any specific Graded Farmland Contract will be known by the corresponding grade number. For example, any Grade 200 Contract would refer to a “Grade 200 Farmland Due Bill” (200-FDB). Grade 300, 400, 500 and 600 Due Bills would work similarly. Delivery map zone particulars will further mandate each due bill being more explicitly defined as per a specific delivery region.

In preferred embodiments of the software product of the delivery system of the present invention, the software means for using a due bill process include software means for a trading system. In the preferred trading system, a due bill delivery allows an option for the issuer/short to buyout of the due bill obligation; the issuer/short to extend the due bill obligation for a period of time by transferring extension fees from the issuer's/short's account to the holder's/long's account; and the holder/long of a due bill obligation to at times exercise a termination option. Preferred embodiments also include software means for determining prices of the issuer's buyout option, the issuer's extension option, and the holder's termination option. The preferred software package will consider the absolute level of interest rate, volatility expectations and market conditions to derive costs for due bill option and termination fees.

It is the intent of the contract design to provide the safest delivery type mechanism through the use of an alternative delivery concept that can act as a counterweight to possible supply and demand imbalances. The hybrid delivery characteristics of the due bill provide such assurances. Options extended to the short and long positions, balances supply and demand conditions of the marketplace. An optimal hybrid delivery system considers the fundamentals of the particular commodity along with the inherent advantages of being long or short. A delivery mechanism must address how conditions favor both sides of the market at different times.

The preferred farmland contract size of the delivery system of the present invention is 40 acres, and the delivery system may deliver up to four contiguous contracts. The contract size (40 acres) preferably acts as representative rectangular parcels for bundling, or grouping purposes, referred to herein as “blocks,” or “building blocks” each of which represents a percentage of a perfect one square mile township section. The use of blocks uniquely acts to provide a requirement for acceptable delivery configurations where up to four contiguous parcels may be tendered for delivery. Delivery of contiguous contracts is subject to a favorable settlement matching process. For example, in the preferred system, delivery can consist of 1 to 4 contiguous contracts with each being a nominal size of 40 acres with a plus/minus delivery variance defined by the system.

Contract deliveries include all deliveries that can be delivery system recognized rectangular shaped 1/16 of a township section, also known as a “quarter of a quarter section” and being approximately in dimension 1,320′×1,320′. Any 1 to 4 contract delivery must meet system delivery requirements, including an approximate minimum running 660′ of public road frontage and be contiguous for 2 to 4 contract deliveries. The system may approve non-conforming 1 to 4 contract deliveries for delivery that can be verified to contract specifications. The system also accommodates non-perfectly sized sections and subsections thereof, as well as irregularly shaped parcels and parcels not of the Township and Section type PLSS.

In preferred embodiments of the delivery system of the present invention, the software product also includes software means for sectioning parcels of land that are the subject of farmland contracts into a series of parcels based upon desired land quality classifications. These software means may include the capability of inserting internal dividing lines onto a map of the parcel, defining a series of internal parcels within the overall parcel. The internal parcels may have different shapes and sizes. However, the system will only section the overall parcel such that the internal parcels are multiples of a standard block and such that the internal parcel meets all internal frontage requirements.

In its most basic form, the index system for developing farmland indexes of the present invention is a computerized system including a processor and memory that stores a software product. The software product includes software means for receiving deed information for properties, receiving “Land Capability Class” ratings for properties, and receiving “Farmland Classifications” for properties, discarding ineligible properties from analysis, and assigning a price a per acre for designed farmland classes.

The deed information for properties will most likely be received from county courthouses. Deed information includes property transaction details, such as price, acreage, and details about the property. The details may include what type of property it is, e.g. commercial, residential, or farmland; aspects of the property, such as its shape, size, or other components; the existence of a residential or other structure on the property, and possibly its value alone. It is preferred that the software product receive the deed information from a number of polling locations with a geographical area, preferably eight polling locations per state. With this preferred schema, each location contributes ⅛ to the state price per acre. It is understood that there may be more or less than eight polling locations and the geographical area may not be a state. In all embodiments, however, each polling location contributes an inverse of the total number of polling locations toward data for that geographical area.

In preferred embodiments, the index system's software means for discarding ineligible properties from analysis may be based on these details. In particular, the system first determines if a reviewed property is residential or commercial. If a system review verifies data to be residential or commercial, such property is discarded from index use. The system also determines if the property meets the anticipated acreage size minimum of a “quarter of a quarter section,” being approximately 40 acres for inclusion in an index. Property of less than sufficient size is discarded from farmland index use. The system also determines if the property shape, size, or other components prevents proper analysis of the parcel to be assigned an index class. Properties not capable of such analysis will be discarded. The system also determines the existence of a residential structure within the farmland property boundaries. The inability to adequately assign an accurate value to said improvement will disqualify property from index inclusion. Finally, the system also determines the amount of defined perennial water and wetlands as per an acceptable GIS system or Web Soil Survey analysis. The system will define the percentage amount of water and wetlands per parcel as per an acceptable GIS system or web soil survey analysis. The system will discard from calculation parcels that exceed the maximum acceptable percentage of water and wetlands. The system may also determine if a property qualifies as forested land. Forested lands may be included in a specific index and excluded from others.

Once a property is determined to be a farmland eligible parcel, the index system further analyzes it using the capability class ratings and the farmland classifications input into the software product. The NRCS, a branch of the USDA, uses classifications for farmland and these inputs preferably are the NRCS “Capability Classes” as part of “Land Capability Classifications” (622.02) and “Farmland Classifications” (622.03), both being part of NSSH part 622, Ecological and Interpretive Groups. The system also uses GIS technology to verify data as to acceptability for inclusion into any index.

The NRCS has eight distinct Land Capability Classes numbered I through VIII as defined in Section 622.02 of its NSSH. The system determines what Capability Classes may be included in the index. The system determines a minimum or maximum percentage for any Capability Class that may be included in the index. The system further determines the inclusion or exclusion of any Land Capability Classes from particular indexes. The system further determines the use or non-use of irrigation for indexes that can be irrigated or non-irrigated farmland. The system then accordingly uses either non-irrigated or irrigated land capability class ratings I, II, III, IV, V, VI, VII and VIII respectively.

The system also uses Farmland Classifications defined by the NRCS in Section 622.03 of the NSSH for creation of “Prime Farmland Indexes.” The percentage of NRCS defined farmland as “Prime Farmland,” “Not Prime Farmland,” “Farmland of Statewide Importance,” “Farmland of Unique Importance,” “Prime Farmland if drained,” “Prime Farmland if irrigated,” “Prime Farmland if irrigated and drained,” etc. is determined. The system requires a minimum percentage, preferably 75%, of property to be Prime Farmland, Farmland of Statewide Importance, Farmland of Unique Importance, while allowing for limited amounts of Prime Farmland if drained for inclusion in a Non-Irrigated Prime Farmland Index. The system determines which Farmland Classifications may be included in the index and can allow for varying percentages of any Farmland Classification. The system further allows for the use of Prime Farmland if irrigated for construction of Irrigated Prime Farmland Indexes.

In preferred embodiments, the system uses the Land Capability Classifications to divide the index into at least two sub-indexes generally based on land quality as defined by Land Capability Classes. The system preferably defines the reviewed farmland that meets the requirements as Tier I Farmland, Tier II Farmland, or Prime Farmland. Tier I Farmland Indexes have a minimum percentage, preferably 75%, of property being in Capability Class II or higher. Tier II Farmland Indexes require farmland with a minimum percentage, preferably 75%, of property being Capability Class V or higher. As such, a Tier I index may be thought of as higher quality land that would be conducive to being cropland, for example. A Tier II index represents lesser quality type land that would be more commonly identified as pasture and rangeland, for example. The system assigns less stringent Land Capability Classifications requirements for a Tier II index.

In preferred embodiments, the software product of the system also uses the NRCS Land Capability Classes to assign a “grade” to each property, which leads to even more defined land quality indexes. The system uses NRCS Capability Classes I through VIII as part of “Land Capability Classifications” (622.02) and “Capability Classes” to categorize acceptable farmland parcels into Grade 200, Grade 300, Grade 400, Grade 500 and Grade 600 farmland. As grades elevate they incrementally include higher quality Land Capability Class requirements or higher percentages of such classes and less acceptance of lower graded Land Capability Classes. Grades are constructed with the percentage total of each Capability Class on a per parcel basis multiplied by an assigned ranking for the class. The sum is totaled to derive a grade. The ranking for Capability Class I is 700, Class II is 600, Class III is 500, Class IV is 400, Class V is 300, Class VI is 200, Class VII is 100 and Class VIII is 0. Specific indexes may use a higher or lower grading system than presented. The total ranking of the acreage determines what index the farmland will qualify for. One of ordinary skill in the art will recognize that the specific grade numbers indicated above are essentially arbitrary and there are many ways in which the Capability Classes may be translated into grades. Each of these ways is contemplated as being within the scope of the present invention.

It is preferred that the system update its data at least once a month. This provides an index that provides, on an at least monthly basis, the average price of farmland on a per acre basis. In some cases, however, there will be no new data within the month. The system determines which specific counties are used to get a fair and accurate price per acre for defined states and regions. Under the circumstances where no new data is provided for a certain geographical area, the system's software includes means to exclude any data point that cannot provide fresh sales pricing since the last collection date; rely on local representatives as a data source for a survey of any price appreciation or depreciation of index class farmland where no acceptable sales have occurred at a polling location since the last survey date; and/or choose to substitute adjacent county data in lieu of insufficient data being available from a polling location.

It is preferred that the software product also have means for rebalancing data for a geographical region when necessary. The index may be rebalanced, for example, by adding or subtracting data collection points for a more representative geographical area analysis, in order to avoid an over concentration from any region or underrepresentation of a significant crop region.

Moreover, the system may lower or raise the percentage weighting from any region to better represent areas with significantly more sales data available or to maintain a specified diversification. As information is gathered from data points, indexes may be broadened to include new geographic regions and polling locations. Areas of increasing or decreasing production importance may be added or deleted. These are but a few examples of logical manipulations of the data to make the index better representative of the actual market, or of ways to create sub-indexes of manipulated versus unmanipulated indexes. Similar logical manipulations are contemplated as being included within the scope of the present invention.

The preferred software product also includes means for weighting certain deed information based on the transaction described in the deed. The system may assign percentage weightings dependent on the size of the applicable transactions at each data collection point on a per county basis. If only five sales from one collection point fit the criteria of an index and four of those sales are fifty acre parcels and one is a five hundred acre parcel, for example, the system will assign the five hundred acre parcel a greater than 20% weighting on the price per acre for that collection point.

In preferred embodiments, the software product includes means for accounting for data points that may be unduly affected in pricing due to proximity to encroaching metropolitan area development. The software product also preferably includes means for creating sub-indexes, some of which include these data points, and some of which exclude them.

The preferred software product also includes means for receiving information on water availability from a particular water source. The software product also preferably includes means for determining which collection locations are within a specified range of the water source and therefore most applicable for this type of information receipt. The means for receiving information on water availability includes means for overlaying United States Geological Survey (USGS) or other geological survey services water level data with irrigated Land Capability Classes and Farmland Classifications along with index creation methodology. The information on water availability may include information on water stress points, estimated usable water years, and water level changes. The preferred software product also includes means for creating “synthetic water indexes” by using irrigated Farmland Capability Classes, irrigated Farmland Classifications, surveys of the High Plains Aquifer, also known as the Ogallala Aquifer, regions provided by the USGS or other credible surveys, and design specifications and requirements of the system.

The present invention specifically contemplates the Ogallala Aquifer for this last embodiment. Indexes are structured that specifically use data provided by the USGS to create indexes dependent on water availability from the Ogallala Aquifer. A typical USGS map that provides data on the Ogallala Aquifer indicates water level changes in the various geographical areas affected by the Ogallala Aquifer by overlaying the map with different colors associated with different quantities of water decline or rise. These maps provide information to the index system through the software means for receiving water availability information.

The High Plains Aquifer is an expansive groundwater reservoir underlying approximately 111 million acres of eight very productive agricultural states. While the aquifer is renewable, discharge rates exceeds the recharge rate. Withdraws for increasing irrigation uses are the primary source of the imbalance. Water level changes vary greatly across the region with most showing some degree of decline. A number of regions have witnessed no change and few show a rise in water levels. For the purposes of farmland indexes the continued availability of water affects pricing.

The farmland index developed by the system of the present invention using the software means for receiving information on water availability and software means for overlaying USGS water level data will specifically design farmland indexes where price is dependent of actual water level changes or anticipated water level changes. These indexes are, therefore, in effect, water indexes. The system allows for matching regional water stress points with productive capabilities of irrigated farmland to create farmland (water) indexes. While technically a farmland index, a homogeneous farmland index with irrigation considerations to the Ogallala Aquifer region is equivalent to a water index. With an expectation of a significant water level decline in an index region, one would sell the index. If water use becomes more restrictive or curtailed the price per acre of the farmland of the index should depreciate.

The system selects counties within or adjacent to the Ogallala Aquifer as polling locations. Indexes created will be state or regional specific and associated with the Ogallala Aquifer region. The system determines county collection points from data provided by the USGS that indicates such points as subject to varying degrees of water vulnerability or level changes. The system overlays determined “county water stress” points with agricultural contributions of the land to determine data collection locations. With the use of irrigated farmland sales, NRCS public information, data provided by the USGS, and devised requirements and specifications unique to the overlay process farmland indexes can be crafted that are actually “de facto water indexes”.

In preferred embodiments, the software product also includes means for receiving a capability sub-class for a property. The capability sub-class is preferably those Capability Sub-classes as defined under Land Capability Classification 622.02, such as, sub-class “e,” “w,” “s,” and “c.” The software product may also include means for receiving soil type information for a property. The soil type information is preferably from the NRCS report “Soil Taxonomy, A Basic System of Soil Classification for Making and Interpreting Soil Surveys,” Agricultural Handbook 436. The system categorizes property soil percentages by accounting for the twelve different orders of soil taxonomy.

In its most basic form, the index of the present invention may be manipulated to indicate an average farmland price in a specific geographical region and determines these prices by a number of data inputs, including recorded deeds, capability class ratings, and farmland classifications.

In some embodiments, the specific geographical area is defined by the index. Exemplary index defined geographical regions include, but are not limited to, “Corn Belt,” “Lake Region,” “Northern Plains,” “Southern Plains,” “Mid-Plains,” “Delta,” “Pacific Region”, “Mountain,” and “Southeast.” Regions may be combined for broader composite indexes or subdivided for smaller index regions. In other embodiments, the specific geographical region is a state or county. In addition, new regions, both smaller and larger than those discussed above, may be defined and used for index creation. The various indexes and sub-indexes allow for regional flexibility, along with land quality variations.

The data inputs for the index may include recorded deeds, land capability class ratings, land capability sub-class ratings, farmland classifications, and soil type information, as discussed above with respect to the index system of the present invention.

The index of the present invention may provide a grade for a property, as described above with respect to the system of the present invention. Also as described above, it is preferred that the index is updated no less frequently than once a month, and may be divided into at least two sub-indexes based on land quality.

The index may be used as industry price barometers for farmland pricing, as well as for the creation of index funds, OTC products, and futures options and contracts. The indexes allow for the use of systems that specifically commoditize farmland. The inventor has patent pending systems for the commoditization of farmland for instruments such as futures contracts.

The present invention allows for the development of the farmland index first and letting such indexes be applied towards the development of additional products. The index is typical of the data gathering process described above, where pertinent information is structured into a standardized form that is representative of farmland pricing.

The index is not a contract in itself, but a vehicle that allows for the creations of different contracts such as swaps and other OTC products along with exchange traded instruments.

Exchange traded products may include varying futures and options contracts and ETFs. Indexes may further be used to broaden the depth and improve accuracy of specific commodity indexes. Traditional agricultural indexes account for such things as row crops, fruits, nuts, vegetables, rice etc. There is currently no method for these indexes to account for farmland and water. Similarly, livestock commodity indexes include live cattle, hogs, chicken and sheep but cannot account for grazing land, pasture land and water. Forest land can accommodate items like lumber and plywood but not account for the forest land exposure. A farmland index that provides for the creation of OTC or exchange traded products allows for more robust agricultural, livestock and forest commodity indexes.

Any instrument that ultimately is created from the index is “cash settled” off the index price itself. This provides increased flexibility and an ability to customize OTC products for client specifications.

A practical example of the system of the present invention is described as follows: The use of a GIS system such as Web Soil Survey is used for the analysis of any farmland sales. As initial data is retrieved from data points, such as county courthouses, many irrelevant sales are downloaded. The system is used to discard anything that is not farmland, such as commercial and residential properties. The system also filters parcels of farmland that do not meet a prescribed minimum size. The system may also eliminate any parcel of farmland that cannot adequately be mapped and documented to system GIS capabilities. Once a sale has been determined as farmland it is sorted as to percentage weightings for Land Capability Classes (including sub-classes), Farmland Classifications and soil types. Sorting determines what “Farmland Index Buckets” the property may fall into. Eligible farmland, including land commonly known as but not limited to cropland, range land, pasture land and forest land will most likely fall into multiple “grading buckets” that can be utilized for different indexes. With fulfillment of designed index requirements a property may be included in index calculations. In the event of buildings being located on the property, the price of the building needs to be accounted for to eventually derive a price per acre exclusive of such improvements. The inability to adequately account for extraneous and significantly priced buildings such as a residential home excludes the parcel from inclusion in an index. The system will account for the existence of permanent water and wet conditions on a per parcel basis and determine if the property meets percentage requirements for index. Ponds, lakes and wetlands in excess of the maximum percentage distort the price per acre of the sale. The system determines the amount of such land on a per parcel basis and excludes any parcels that exceed the maximum percentage allowed per parcel.

Therefore it is an aspect of the present invention to provide a delivery system for farmland contracts that uses conversion factors to equalize deliverability.

It is a further aspect of the present invention to provide a delivery system that updates its conversion factors at least annually and uses conversion factor adjustments.

It is a further aspect of the present invention to provide a delivery system that uses a due bill process.

It is a further aspect of the present invention to provide an index system for creating a farmland index specific to farmland real estate that approximates farmland value based on attributes of the farmland.

It is a further aspect of the present invention to provide an index that provides prices on a per acre basis for varying types of farmland.

It is a further aspect of the present invention to provide an index that uses objective valuation methodologies.

It is a further aspect of the present invention to provide an index that is not limited to land that is currently under cultivation.

It is a further aspect of the present invention to provide an index that is not limited to investment land or land that is in foreclosure.

It is a still further aspect of the present invention to provide an index that is adapted for replication in physical or exchange traded markets.

These aspects of the present invention are not meant to be exclusive and other features, aspects, and advantages of the present invention will be readily apparent to those of ordinary skill in the art when read in conjunction with the following description and accompanying drawings.

### BRIEF DESCRIPTION OF THE DRAWINGS

FIG. 1 is a screen shot of a prior art Farmland Classification map produced by the NRCS

Web Soil Survey program.

FIG. 2 is a screen shot of a prior art Farmland Classification summary for the map of FIG. 1.

FIG. 3 is a screen shot of a boundary line overlaid by a Farmland Classification map by the system for commoditizing farmland.

FIG. 4 is a screen shot of a boundary line and a series of dividing lines defining a series of internal parcels overlaid by a Farmland Classification map by the one embodiment of the system for commoditizing farmland.

FIG. 5 is a block diagram of the delivery system of the present invention.

FIG. 6 is an overlay of a map showing a quarter of a quarter section of land.

FIG. 7 is a table summarizing a non-irrigated capability class by map unit.

FIG. 8 is a block diagram showing the index system of the present invention, including several of the functions of the software product included in the index system of the present invention.

FIG. 9 is a block diagram showing additional functions of the software product of the index system of the present invention.

FIG. 10 is a block diagram showing the features of the index of the present invention.

FIG. 11 is a map of the United States divided into economic regions.

FIG. 12 is a sample index showing 2010 Western Heartland average acreage prices.

### DETAILED DESCRIPTION OF THE INVENTION

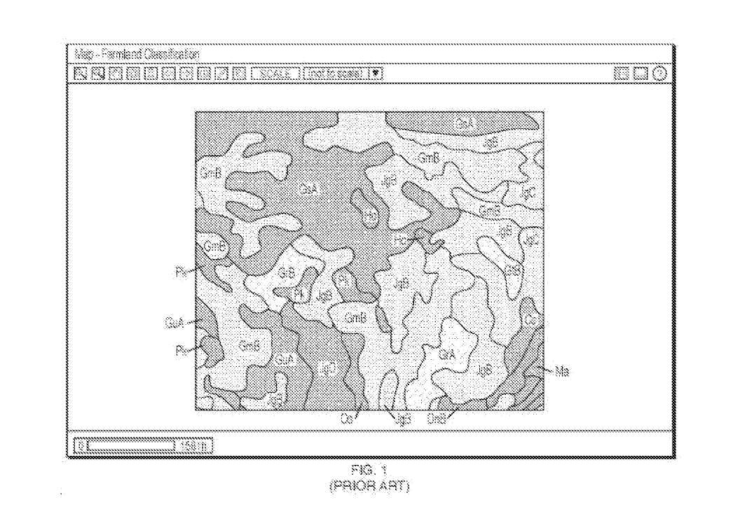

Prior to the development of the present system, the inventor of the present invention first developed a system that accommodated design of farmland futures and options contracts. The contracts were innovatively structured, incorporating an optional delivery “due bill” feature. The system of the present invention utilizes many of the components of this system and these are described below with reference to FIGS. 1-4.

The first component necessary for the implementation of the farmland futures contracts was the development of a system for commoditizing farmland. The inventor of the present invention researched different types of land in an attempt to find a way to create something that could be made into a homogeneous product that could be standardized into a contract that could be traded on an exchange. This research involved discussion with soil scientists, GIS experts, agronomy school professors along with government publication research and library research to better understand agronomy and issues pertaining to farmland and soils in order to find a way to not just allow index based trading, but to have a standardized physical delivery. Index traded contracts exist because it is understood that physical delivery is just not feasible and, prior to the development of the inventors' futures contract system, it was assumed that contracts involving real property could only be index based. What the inventor discovered was that farmland had sufficient generic features that were public and maintained by the NRCS, part of the USDA. After countless attempts during the course of years, the inventor was able to develop a system for commoditizing farmland. Using observed generics features, combined with a scientific methodology the inventor was able to comingle imposed specifications, requirements and restrictions to structure farmland futures contracts with an actual delivery component.

The inventor's system for commoditizing farmland uses selected data from the “Land Capability Classifications” and “Farmland Classifications” of the USDA NRCS to classify land quality, which resulted in the creation of three initial distinct core contracts: Tier 1 Farmland, Tier 2 Farmland, and Prime Farmland, each being categorized under different classification requirements with quality characteristics appealing to different hedging interests. Additionally, Land Capability Classifications serve the purpose of providing a more defined group of contracts. A detailed “grading system” of contracts with Grade 200, Grade 300, Grade 400, Grade 500 and Grade 600 contracts allows for more focused land characteristics than their Tier 1 and Tier 2 counterparts. Basis risk will be further reduced by establishing multiple delivery zones for each core contract allowing for more regionally specific trading hedges.

In the United States, soil data is produced by the National Cooperative Soil Survey and disseminated publicly by the USDA NRCS. At the time of the inventor's last application, NRCS had soil maps and data available online for more than ninety-five percent of the counties in the nation's forty eight contiguous states and anticipates having one hundred percent in the near future. The NRCS has an on-line soil data mapping tool, called the “Web Soil Survey”, which identifies capabilities and characteristics for soils and land and for areas within a tract of land. The Web Soil Survey uses the Land Capability Classifications listed by the NRCS in Section 622.02 of its National Soil Survey Handbook, which include, but are not limited to, Capability Classes I-VIII. The Web Soil Survey also classifies land and areas within a tract of land using the Farmland Classifications listed by the NRCS in Section 622.03 of its National Soil Survey Handbook which include, but are not limited to, “Not prime farmland,” “All areas are prime farmland,” “Prime farmland if irrigated,” “Prime Farmland if drained,” “Prime farmland if irrigated and drained,” “Farmland of statewide importance,” “Farmland of local importance,” and “Farmland of unique importance” etc.

FIG. 1 shows a map of an area of land created by the Web Soil Survey program that identifies portions of land having certain quality characteristics. The area of land is identified in the program as an “area of interest” or “AOI”, which is chosen by the user. The user may only manually draw this onto the map and there is currently no way to define an area of interest in terms of specific geographic coordinates.

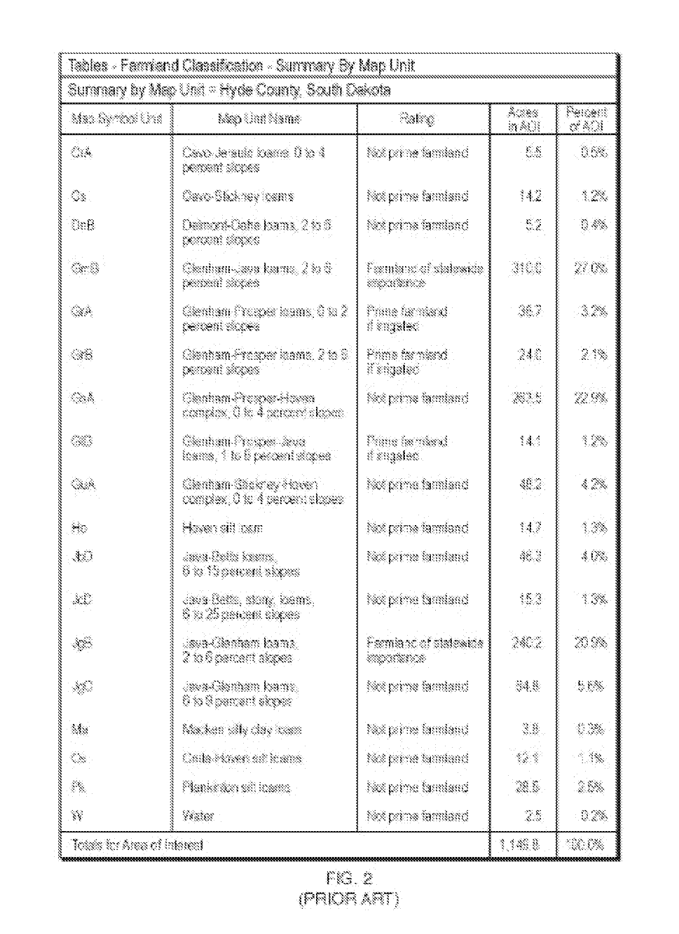

FIG. 2 shows a table of values for the area of interest on the map of FIG. 1, which shows the land classification ratings attributable to the various quality codes, the number of acres in the area of interest having these codes, and the percentage of the overall area of interest that is covered by each code. The Web Soil Survey also classifies land in non-irrigated Farmland Classifications in a manner similar to the classification of non-irrigated Land Capability Class ratings I through VIII, shown on FIG. 2 map.

The NRCS Web Soil Survey did not include sufficient data and methodology by itself to sufficiently allow for a standardized financial instrument such as a futures contract an OTC product or an index. Accordingly, one of the key aspects of the inventors' commoditization system was the application of the soil data with defined requirements and specifications to data identifying specific sales of farmland allowing a homogeneous classification of such parcels into legitimate indexes, futures contracts and OTC Products.

The preferred system for commoditizing farmland utilizes data from the NRCS Web Soil Survey to classify specific parcels of land. The system requires inputs for a particular tract of land within a specified delivery zone that includes boundary data defining the parcel or series of commonly owned parcels making up the total tract of land. Such mapping system may utilize the capabilities of the NRCS “Web Soil Survey”, or may merely import the Web Soil Survey data.

The computer program product includes software that allows inputs of property boundary line data defining a parcel or series of commonly owned parcels, overlays the soil data over the selected parcel or parcels, determines NRCS ratings based upon the overlay of the soil data within the boundary line data, and classifies the parcel. This classification preferably follows the Land Capability Classes specified under NRCS National Soil Survey Handbook and Agricultural Handbook, or Farmland Classifications of the NRCS National Soil Survey Handbook. Selected classifications only will be used to determine qualification for the specific parcel or parcels in meeting the particular requirements of any farmland futures contracts.

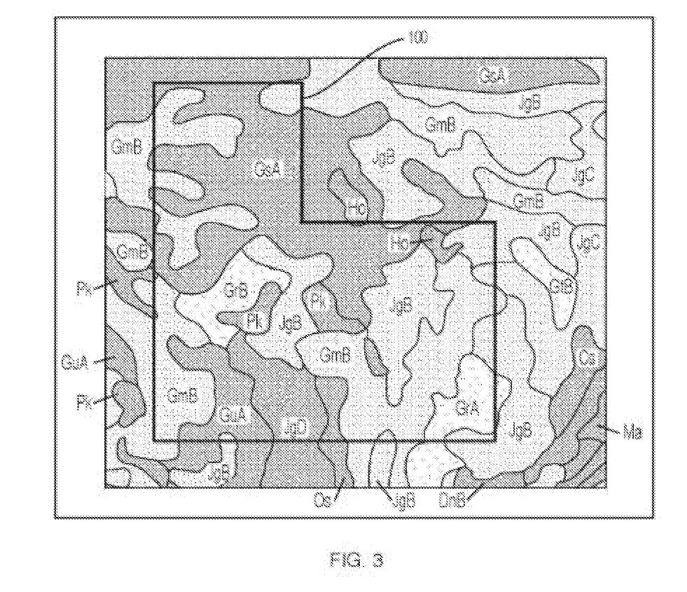

FIG. 3 shows a map overlaid over a boundary line 100 using the system for commoditizing farmland. As shown in FIG. 3, the boundary line 100 is irregularly shaped and is based upon specific geographic coordinates that define a commonly owned parcel. The system for commoditizing farmland uses this boundary line 100 to define the area of interest and then performs the same types of calculations as the Web Soil Survey to identify the various percentages of the parcel that fall within the selected land quality measures. As discussed above, the system's analysis of land quality measures based upon the overlay of the soil data with the boundary line data involves a number of separate determinations. The system determines the percentage of the parcel or parcels of land that is “Prime Farmland”, “Farmland of Statewide Importance”, or “Farmland of Unique Importance”. The system determines the percentage of the parcel or parcels of land that is “Prime Farmland if drained”, “Prime Farmland if irrigated” or “Prime Farmland if irrigated and drained”. The system determines the percentage of the parcel or parcels of land that is “Not Prime Farmland”. The system determines the percentage of the parcel or parcels of land that is water. The system determines the percentage of the parcel or parcels of land that falls under other Farmland Classifications. The system determines the percentage of the parcel or parcels having non-irrigated capability class ratings I, II, III, IV, V, VI, and VII respectively.

The system then performs the additional step of analyzing the percentages and classifying the parcel as “Prime Farmland”, “Tier 1 Farmland”, or “Tier 2 Farmland” based upon the result of the analysis of land quality measures. The system will further analyze land and determine percentages of land as “Grade 200”, “Grade 300”, “Grade 400”, “Grade 500” and “Grade 600”. This land quality classification is preferably performed as follows.

The preferred system classifies a parcel or parcels of land as “Prime Farmland” if the following conditions are met. At least an established minimum percentage of land is “Prime Farmland”, “Farmland of Statewide Importance”, or “Farmland of Unique Importance”; no more than an established maximum percentage of the total land. may be designated as “Not Prime Farmland” or other stipulated Farmland Classifications; no more than a maximum percentage of the land can consist of water (including wetlands); and no more than a total percentage may include “Not Prime Farmland” and “water” and the balance of the land is designated “Prime Farmland if drained”, “Prime Farmland if irrigated” or “Prime Farmland if irrigated and drained” and may further include other farmland classifications if determined beneficial to the contract.

The preferred system classifies a parcel or parcels of land as “Tier I Farmland” if at least the following conditions are met. At least an established minimum of the land has a non-irrigated capability class rating of I, II or III. The remaining land may include non-irrigated rated land capability classifications IV, V, and VI, with the limiting condition that no more than an established maximum percentage of the land may be of Classification VI. Water and wetlands may in total account for an established maximum percentage of the property. However, the total of land capability class VI and water may not, in total, account for more than an established maximum percentage.

The preferred system classifies a parcel or parcels of land as “Tier II Farmland” if the following conditions are met. At least an established minimum of the land delivered has a non-irrigated capability class rating of VI or higher. The remaining land may include land of capability classification VII, with the limiting condition that no more than an established maximum percentage of the land may be of Classification VII. Water may in total account for an established maximum percentage of the property. However, the total of land capability class VII and water may not, in total, account for more than an established maximum percentage.

The preferred system classifies a parcel or parcels of land as “Grade 200”, “Grade 300”, “Grade 400”, “Grade 500” and “Grade 600” Farmland if at least the following conditions are met. The system determines an established minimum and maximum percentage for each Non-Irrigated and Irrigated Land Capability Class I through VIII parcel for determination of a maximum “grade”. The system will assign increasingly higher quality standards for higher grades. Example, Grade 600 will have higher Land Capability Classification percentage standards than Grade 500. Grade 500 will have higher percentage standards than Grade 400, working similarly down to the Grade 200. Water and wetlands may in total account for an established maximum percentage of the property.

The system allows for all of the above preferred methods of classifying farmland to be done in a similar structure using irrigated farmland in place of non-irrigated farmland.

In the preferred commoditization system as per patent application Ser. No. 12/322,666, filed on Feb. 5, 2009, each size designation corresponds to a “Contract Grouping Designation” for a specific contract, each of which had a set of delivery requirements unique to such designation. Designation I, II, III, IV and V will specify a minimum and maximum number of contracts deliverable per each designation and further have respective “building block” delivery guidelines for acceptable configurations within a township section.

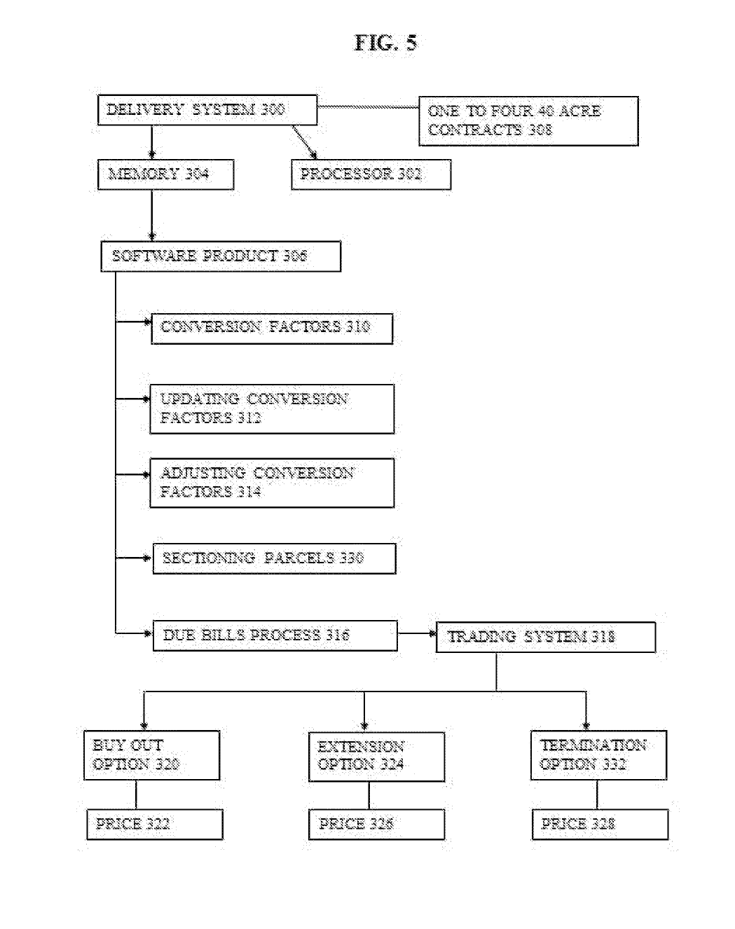

Referring now to FIG. 5, a block diagram showing the functions of delivery system 300 of the present invention is shown. Delivery system 300 includes processor 302, memory 304, and software product 306, stored within memory 304. Delivery system 300 delivers farmland contracts of between one and four 40 acre 308 parcels of land. Software product 302 includes software means for using conversion factors 310 for equalizing deliverability; updating conversion factors 312 at least annually; adjusting conversion factors 314; using a due bill process 316; and sectioning parcels 330 of land. Software means for using a due bill process 316 includes means for using a trading system 318 that allows for a short buyout option 320, a short extension option 324, and a long termination option 326, and calculating the prices 322, 326, and 328, respectively, for those options.

Conversion factors 310 are used to account for pricing disparities across similarly rated lands from state to state. Updating conversion factors 312 occurs at least yearly as base price data for states are made available by the USDA National Agricultural Statistics Services. Adjusting conversion factors 314 is used for selected states maintaining anti-corporate farming laws. The conversion factor methodology allows for discounted factoring for states with ownership restrictions. The system determines adjusted percentage conversion factors designed to lessen the probability of delivery from an anti-corporate farming law states.

Using a due bill process 316 incorporates a due bill process with such instrument having embedded options to both the issuer and holder. The life of such an instrument is preferably up to 12 months in duration. The due bill provides further liquidity to the contracts. Due bill process 316 operates as follows: All parties having agreed to sell farmland under futures contracts and intending to make physical delivery must provide the system information identifying the property to be delivered, or a “due bill” promising to deliver the acceptable property at a later date as per delivery rules. Using a due bill process 316 entails using a trading system 318. Using a trading system 318 allows an option for the issuer/short to buyout 320 of the due bill obligation; the issuer/short to extend 324 the due bill obligation for a period of time by transferring extension fees from the issuer's/short's account to the holder's/long's account; and the holder/long of a due bill obligation to at times exercise a termination option 332. Using a trading system 318 also entails determining prices 322, 326, and 328 of the issuer's buyout option, the issuer's extension option, and the holder's termination option, respectively. Software means for using a trading system 318 considers the absolute level of interest rate, volatility expectations and market conditions to derive costs for due bill option and termination fees.

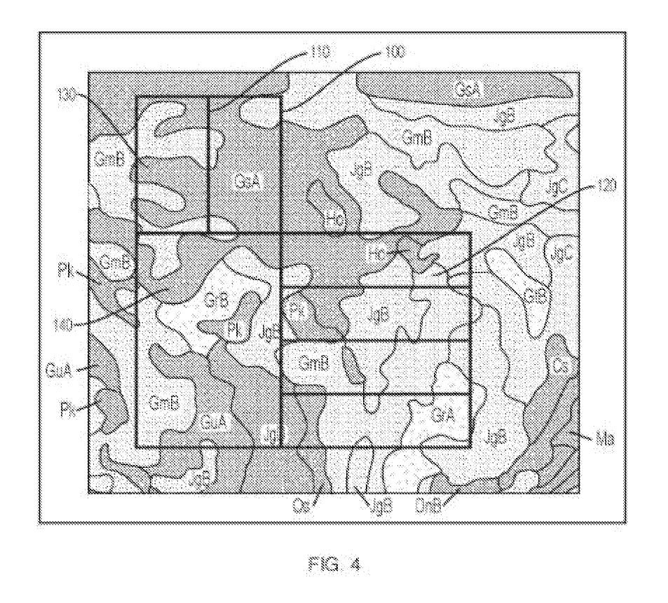

Referring again to FIG. 4, some embodiments of delivery system 300 have the capability of inserting internal dividing lines 110 defining a series of internal parcels 120, 130, 140 within the overall parcel. As shown in FIG. 4, the internal parcels 120, 130, 140 may have different shapes and sizes. However, the system will only section the overall parcel such that the internal parcels are multiples of a standard block and such that the internal parcel meets all internal frontage requirements.

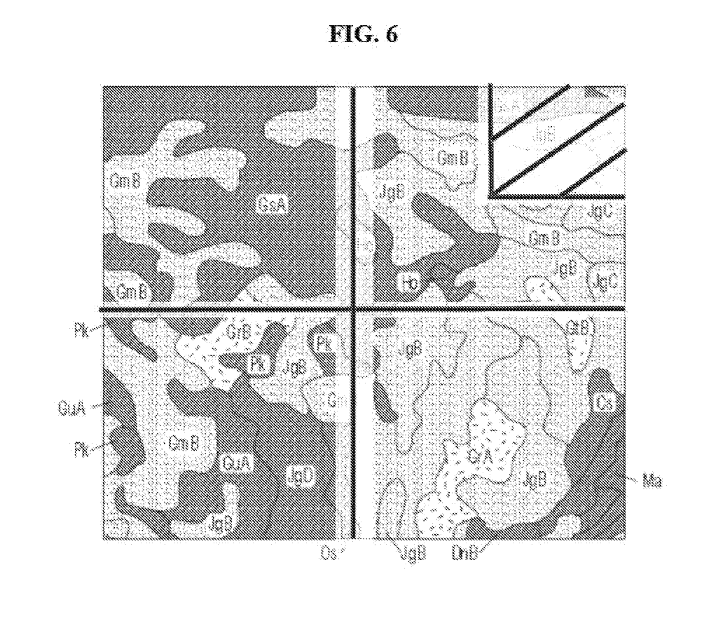

Now referring to FIG. 6, a “quarter of a quarter section” of land is shown. Farmland contract deliveries include all deliveries that can be system recognized rectangular shaped 1/16ths of a township section, also known as a “quarter of a quarter section” and being approximately in dimension 1,320′×1,320′. Any 1 to 4 contract 308 delivery must meet system delivery requirements, including an approximate minimum running 660′ of public road frontage and be contiguous for 2 to 4 contract deliveries. In addition to substantially square parcels of land, such as that shown in FIG. 6, delivery system 300 may approve non-conforming 1 to 4 contract deliveries for delivery that can be verified to contract specifications, non-perfectly sized sections and subsections thereof, and irregularly shaped parcels and parcels not of the Township and Section type PLSS.

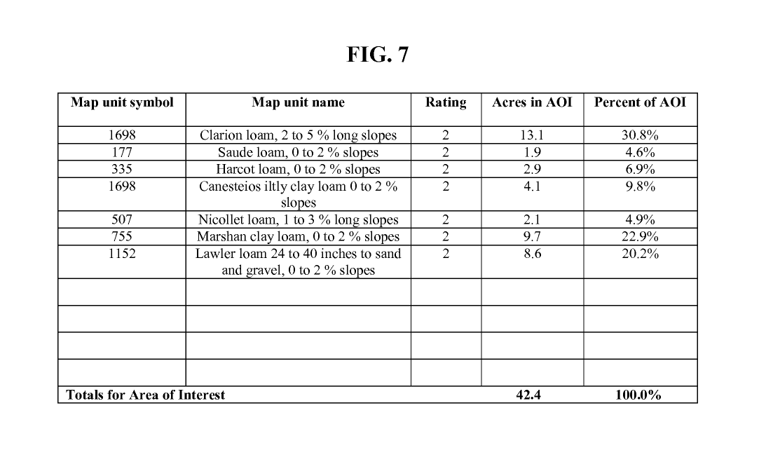

Now referring to FIG. 7, a table summarizing a non-irrigated capability class by map unit is included. This table is an example of a newer version of the type of shown in FIG. 2, as described above. FIG. 7 shows different types of information, as well as different ways to present the same information, from that shown in FIG. 2.

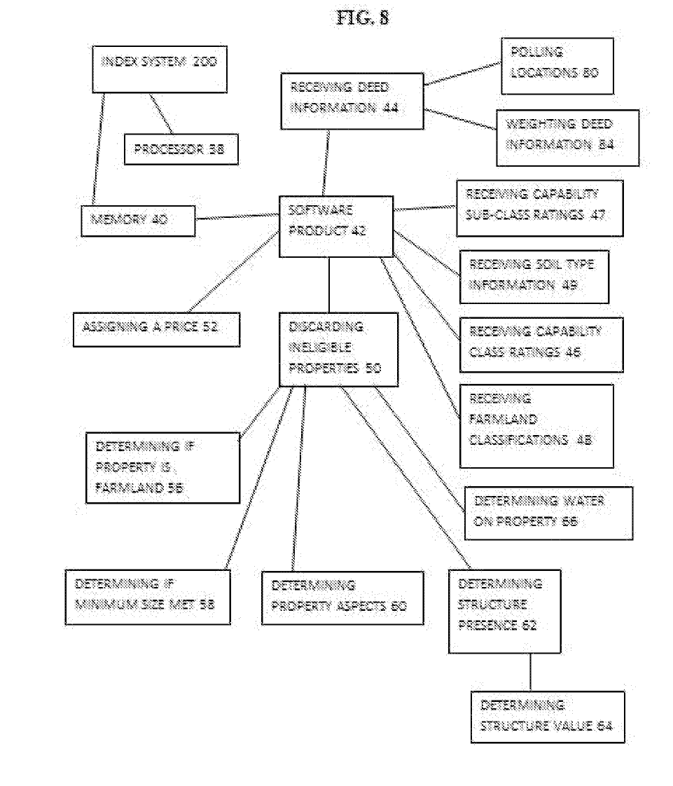

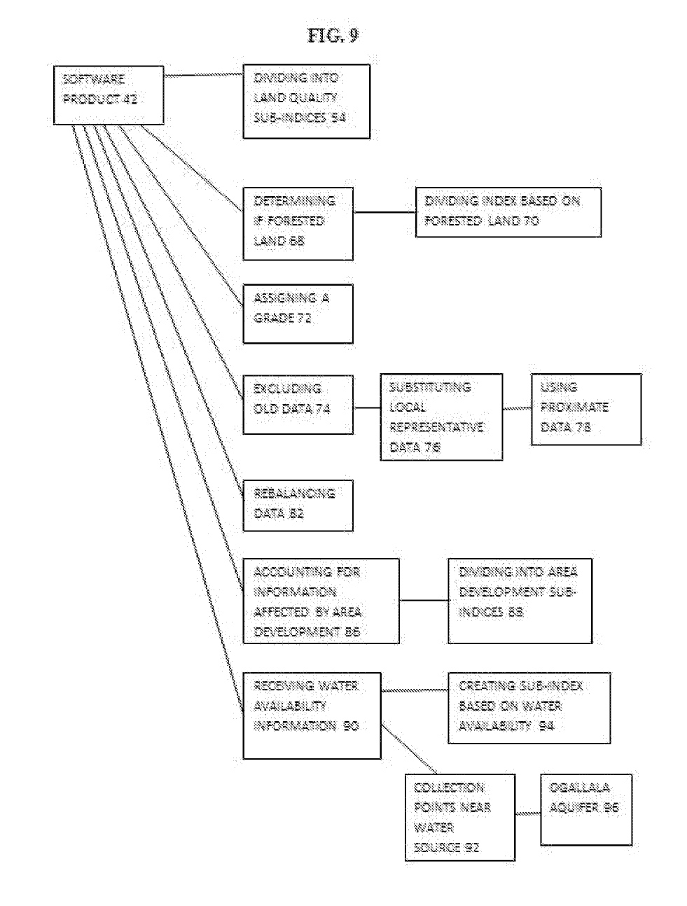

Referring now to FIGS. 8 and 9, block diagrams of index system 200 of the present invention, and in particular, the functions of software product 42 are shown. Index system 200 is a computerized system including processor 38 and memory 40, which stores software product 42. Software product 42 includes a number of software means as described above. These means include software means for receiving deed information 44 from various polling locations 80; weighting the deed information 84; receiving capability class ratings 46; receiving capability sub-class ratings 47; receiving soil type information 49; receiving farmland capabilities 48; discarding ineligible properties 50; assigning a price 52 to a property; dividing the index into land quality sub-indexes 54; determining if a property includes forested land 68; dividing the index into sub-indexes based on the presence or absence of forested land 70; assigning a grade to the property 72; excluding old data from the index 74; substituting local representative data 76 when no new data is available; using data from proximate counties 78 when no new data is available; rebalancing data 82 when necessary; accounting for information affected by metropolitan area development 86 proximate to the property; dividing the index into sub-indexes either including or excluding such data points 88; receiving water availability information 90 from collection locations near a specific water source 92, specifically the Ogallala Aquifer 96; and creating a sub-index based on water availability 94.

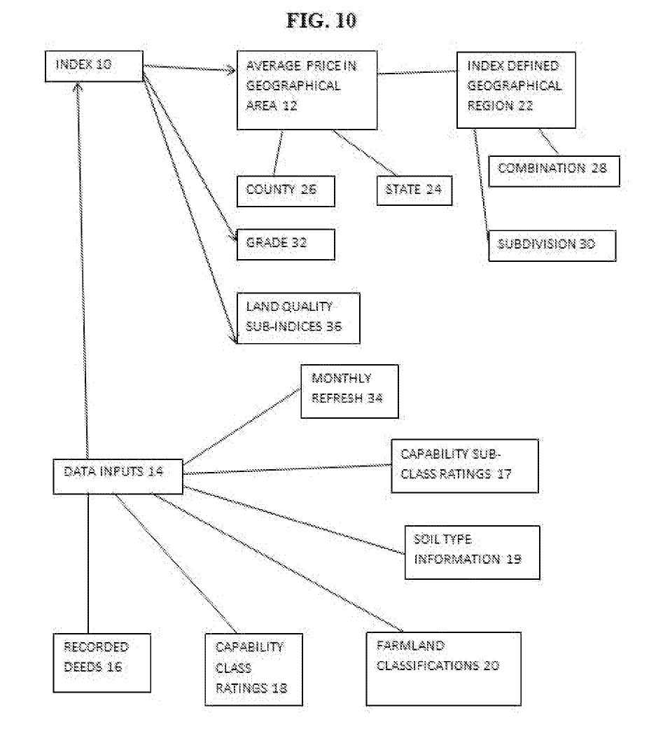

Referring now to FIG. 10, features of index 10, created by index system 200, are shown. Index 10 provides the average price for farmland in a geographical area 12. The geographical area may be an index defined geographical area 22, a combination 28 of index defined geographical areas 22, a subdivision 30 of index defined geographical are 22, a state 24, or a county 26. Index 10 provides average price 12 by analyzing certain data inputs 14, including recorded deeds 16, capability class ratings 18, capability sub-class ratings 17, soil type information 19, and farmland classifications 20. Index 10 is refreshed at least monthly 34. Index 10 also provides grade 32 for properties and land quality based sub-indexes 36.

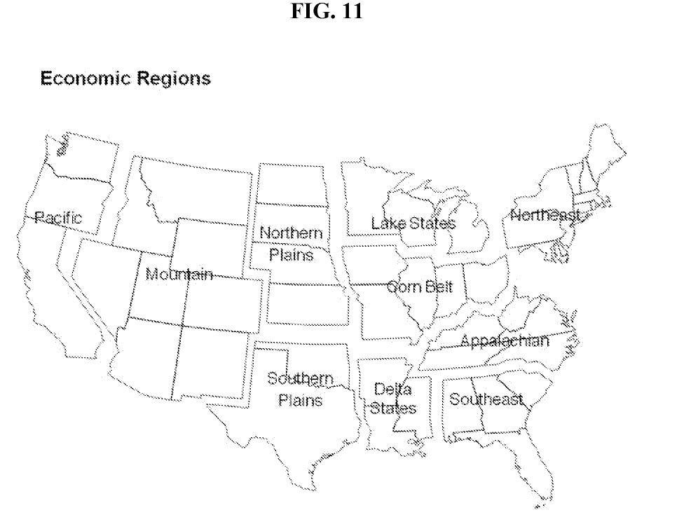

Referring now to FIG. 11, a map of the United States is shown divided into economic regions. These are an example of index defined geographical areas 22.

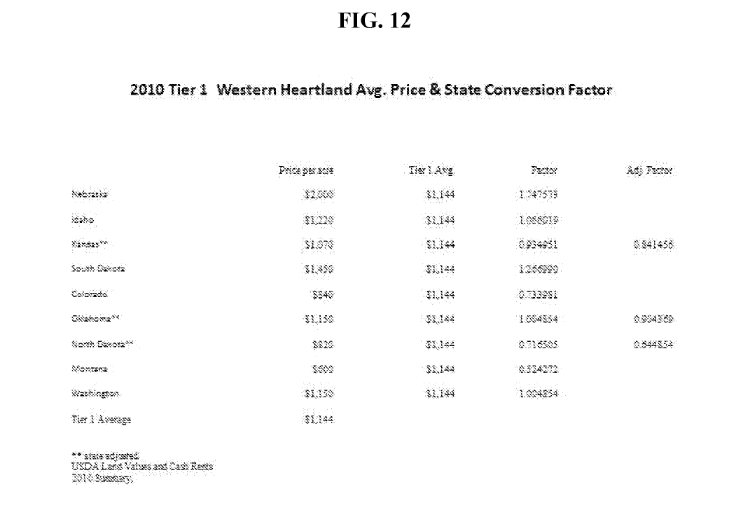

Referring now to FIG. 12, 2010 average prices in the western heartland are shown. This is a sample product of index system 200. It shows the average of the price per acre of USDA most recent state non-irrigated cropland price for all states in Tier 1 Western Heartland zone, or “Tier 1 WH average price.” The factor is the price per acre per state/Tier 1 average. There is a 10% adjustment for states with ownership hindrances. The factor allows for trading the average price of non-irrigated cropland (Tier 1) for a system determined zone and equalizes all the states within that zone for delivery. The average price multiplied by the factor is the state benchmark. Factors also provide hedge ratios.

Although the present invention has been described in considerable detail with reference to certain preferred versions thereof, other versions would be readily apparent to those of ordinary skill in the art. Therefore, the spirit and scope of the appended claims should not be limited to the description of the preferred versions contained herein.

We claim:

1. A farmland commoditization hybrid delivery system of farmland contracts comprising:
a processor; and
a memory on which a software product for executing said delivery system is stored, wherein said software product comprises:
software means for using conversion factors for equalizing deliverability;
software means for updating conversion factors;
software means for adjusting conversion factors; and
software means for using a due bill process.

2. The delivery system as claimed in claim 1, wherein said software means for using a due bill process of said software product comprises software means for a trading system allowing for a buyout option for an issuer to buyout of a due bill obligation; an extension option for an issuer to extend a due bill obligation for a period of time; and a termination option for a holder of a due bill obligation to exercise a termination option.

3. The delivery system as claimed in claim 2, wherein said software means for a trading system of said software means for using a due bill process of said software product comprises software means for determining prices for said buyout option, said extension option, and said termination option.

4. The delivery system as claimed in claim 1, wherein a size of said farmland contracts is 40 acres with a delivery variance defined by said delivery system, and said delivery system delivers up to four contiguous farmland contracts.

5. The delivery system as claimed in claim 1, wherein said software product further comprises software means for sectioning parcels of land that are the subject of said farmland contracts into at least two sub-parcels of land based upon land quality classifications.

6. A system for developing a farmland index, comprising:
a processor; and
a memory onto which a software product for developing a farmland index is stored;
wherein said software product for developing a farmland index comprises:
software means for receiving deed information for properties;
software means for receiving capability class ratings for properties;
software means for receiving farmland classifications for properties;
software means for discarding ineligible properties from analysis; and
software means for assigning a price of farmland.

7. The index system as claimed in claim 6, wherein said software product for developing a farmland index further comprises software means for dividing the farmland index into at least two sub-indexes based on land quality.

8. The index system as claimed in claim 6, wherein said software means for discarding ineligible land parcels from analysis of said software product for developing a farmland index comprises:
software means for determining whether a property is farmland;
software means for determining whether a property meets an acreage size minimum;
software means for determining whether an aspect of a property prevents analysis of the property;
software means for determining the presence of a structure on a property and whether a value is assignable to a structure present on a property; and
software means for determining an amount of perennial water and wetlands on a property.

9. The index system as claimed in claim 6, wherein said software product for developing a farmland index further comprises:
software means for determining whether a property qualifies as forested land; and
software means for dividing the farmland index into at least two sub-indexes based on whether a property qualifies as forested land.

10. The index system as claimed in claim 6, wherein said software product for developing a farmland index further comprises software means for assigning a grade to a property.

11. The index system as claimed in claim 6, wherein said software product for developing a farmland index further comprises:
software means for excluding data from the farmland index for a geographical area from which no deed information has been provided since a last deed information collection date;
software means for substituting local representative data regarding farmland price change in a geographical area for deed information when no deed information has been provided since a last deed information collection date; and
software means for using deed information from a geographical area adjacent to a geographical area from which no deed information has been provided since a last deed information collection date for the geographical area from which no deed information has been provided since a last deed information collection date.

12. The index system as claimed in claim 6, wherein:
said software means for receiving deed information for properties of said software product for developing a farmland index comprises software means for receiving data from a plurality of polling locations within a geographical area, wherein data from each of said plurality of polling locations contributes an inverse of a number of the polling locations toward data for the geographical area; and
said software product for developing a farmland index further comprises software means for rebalancing data for a geographical region through manipulation of data from said plurality of polling locations.

13. The index system as claimed in claim 12, wherein said software means for receiving deed information for properties of said software product for developing a farmland index further comprises software means for weighting deed information for properties based on a transaction included in said deed information.

14. The index system as claimed in claim 6, wherein said software product for developing a farmland index further comprises:
software means for accounting for received deed information that is affected by proximity of a property about which the deed information relates to metropolitan area development; and
software means for dividing the farmland index into at least a sub-index including received deed information that is affected by proximity of a property about which the deed information relates to metropolitan area development and a sub-index excluding received deed information that is affected by proximity of a property about which the deed information relates to metropolitan area development.

15. The index system as claimed in claim 6, wherein said software product for developing a farmland index further comprises:
software means for receiving information on water availability from a water source;
software means for determining collection points for deed information, wherein said collection points are within a range from the water source; and
software means for creating a sub-index of farmland pricing within the range from the water source.

16. The index system as claimed in claim 15, wherein the water source is the Ogallala Aquifer.

17. The index system as claimed in claim 6, wherein said software product for developing a farmland index further comprises software means for receiving a capability sub-class for a property and software means for receiving soil type information for a property.

18. An index for providing an average price of farmland, wherein:
said index is manipulatable to indicate said average price in a specific geographical region; and
said index uses a plurality of data inputs to determine said average price, said plurality of data inputs comprising:
recorded deeds;
land capability class ratings; and
farmland classifications.

19. The index as claimed in claim 18, wherein the specific geographical region is an index defined geographical region.

20. The index as claimed in claim 19, wherein said index is manipulatable to indicate said average price in a combination of more than one of said index defined geographical regions.

21. The index as claimed in claim 19, wherein said index is manipulatable to indicate said average price in a subdivision of one of said index defined geographical regions.

22. The index as claimed in claim 18, wherein the specific geographical region is one of a group consisting of a state and a county.

23. The index as claimed in claim 18, wherein said index further provides a grade for farmland.

24. The index as claimed in claim 18, wherein said index is no more than one month out of date.

25. The index as claimed in claim 18, wherein said index is subdivided into at least two sub-indexes based on land quality.

26. The index as claimed in claim 18, wherein said plurality of data inputs further comprise land capability sub-class ratings and soil type information.
